(19) United States
(12) Patent Application Publication
(10) Pub. No.: US 2012/0049417 A1
(43) Pub. Date: Mar. 1, 2012

(54) IMPRINT APPARATUS AND IMPRINT METHOD

(76) Inventor: Ryoichi INANAMI, Yokohama-Shi (JP)

(21) Appl. No.: 13/197,383

(22) Filed: Aug. 3, 2011

(30) Foreign Application Priority Data
Aug. 27, 2010 (JP) 2010-190852

(51) Int. Cl. B29C 35/08; B28B 11/08

(52) U.S. Cl. 264/496; 425/385; 264/293; 425/174.4

(57) ABSTRACT

According to an embodiment, an imprint apparatus includes a template holder, a space adjusting unit, a relative position control unit and a curing unit. The template holder holds a plurality of templates in an arrayed form, each of the templates has a shape of a pattern to be transferred to a substrate to be processed. The space adjusting unit adjusts a space between the templates to a desired value. The relative position control unit controls relative positions of the templates and the substrate to be processed to bring the templates into contact with a resist on the substrate to be processed. The curing unit cures the resist while the templates are in contact with the resist.

### CROSS REFERENCE TO RELATED APPLICATIONS

This application is based upon and claims the benefit of priority from the prior Japanese Patent Application No. 2010-190852, filed on Aug. 27, 2010, the entire contents of which are incorporated herein by reference.

### FIELD

Embodiments described herein relate generally to an imprint apparatus and an imprint method.

### BACKGROUND

According to an imprint lithography technique, concavities and convexities are formed in the surface of a substrate made of, for example, quartz to produce a template (imprint mask), and the template is brought into contact with an incompletely solidified resist material which has been applied to a substrate to be processed. In this condition, the resist material is solidified by, for example, light (ultraviolet (UV) light) irradiation, and the template is lifted up away from the resist material, thereby forming a resist pattern having the inverse of the concavities and convexities of a pattern formed in the template. Such an imprint lithography technique is called light-curing imprinting (UV imprinting). In this specification, the operation of one resist pattern formation by these processes is referred to as an imprint operation.

One imprint operation includes, for example, numbers of processes: dropping of the resist material onto the substrate to be processed, alignment of the template to the substrate to be processed, adjustment of the size and shape of the template to a base pattern, contact of the template with the resist material and filling of the template with the resist material, curing of the resist material, release of the template, and moving the substrate to be processed to a next imprinting position. This has heretofore led to a problem of a significantly low throughput of pattern formation resulting from an increased time for pattern formation in the substrate to be processed when more than one imprint operation are performed for one substrate to be processed.

### BRIEF DESCRIPTION OF THE DRAWINGS

FIG. 1 is a block diagram showing a schematic configuration of an imprint apparatus according to a first embodiment;

FIG. 2 is a plan view of arrayed template holders of FIG. 1;

FIG. 3 is a plan view of the template holder as a unit that constitutes an array;

FIG. 4 is a sectional view of the template holder of FIG. 3;

FIG. 5 is an explanatory diagram of a wafer shot map and a shot sequence;

FIG. 6 is a sectional view of a template holder of an imprint apparatus according to a second embodiment; and

FIG. 7 is an explanatory diagram of a height adjusting method during the release from a template.

### DETAILED DESCRIPTION

Embodiments will now be explained with reference to the accompanying drawings.

According to an embodiment, an imprint apparatus includes a template holder, a space adjusting unit, a relative position control unit and a curing unit. The template holder holds a plurality of templates in an arrayed form, each of the templates has a shape of a pattern to be transferred to a substrate to be processed. The space adjusting unit adjusts a space between the templates to a desired value. The relative position control unit controls relative positions of the templates and the substrate to be processed to bring the templates into contact with a resist on the transferee substrate to be processed. The curing unit cures the resist while the templates are in contact with the resist.

(1) First Embodiment

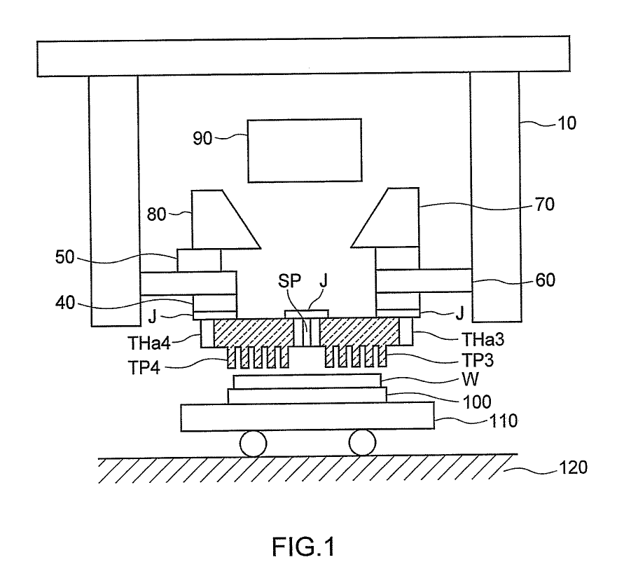

FIG. 1 is a block diagram showing a schematic configuration of an imprint apparatus according to a first embodiment. The imprint apparatus shown in FIG. 1 is a light-curing imprint apparatus which cures a resist by light irradiation after a template is filled with the resist material.

The imprint apparatus according to the present embodiment comprises a plurality of template holders THai (i is a natural number), a template stage 40, a template holding/up-down mechanism 10, an alignment stage 50, an alignment inspection mechanism 70, an alignment sensor 80, a wafer stage 110 for mounting a wafer W, and a UV light source 90. In the present embodiment, the wafer W corresponds to, for example, a substrate to be processed.

The template holders THai hold templates TPj (j is a natural number), respectively. The template stage 40 fixes the template holders THai by, for example, a vacuum chuck. The template holding/up-down mechanism 10 supports the template stage 40 via a base 60, and lifts or drops the template holders

THai via the base 60 and the template stage 40 to bring the templates TPj into contact with a resist material or release the templates TPj.

During an imprint operation, the alignment stage 50, the alignment inspection mechanism 70, and the alignment sensor 80 adjust the horizontal positions of the templates TPj in accordance with a mark pattern (not shown) formed on the wafer W.

The wafer W is fixed to the wafer stage 110 by a wafer chuck 100.

The wafer stage 110 moves on a baseplate 120 and thereby adjusts the position to form a pattern in an imprint operation.

The UV light source 90 cures the resist on the wafer W by light (UV light) irradiation.

A first characteristic of the present embodiment is that the template holders THai respectively holding the templates TPj are fixed to the template stage 40 to perform the imprint operation, thus improving the throughput of pattern formation.

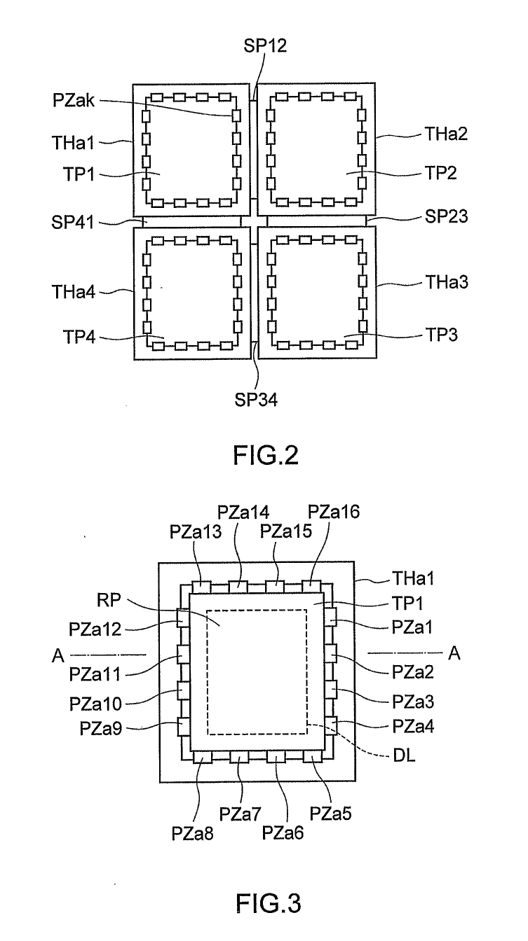

FIG. 2 is a plan view showing an example of the template holders THai (i is a natural number) fixed to the template stage 40. In the example shown in FIG. 2, four template holders THa1 to THa4 (i=1 to 4) are arrayed. Thus, the four templates TP1 to TP4 can be combined together to collectively transfer four shots to the wafer W. Spacers SP12, SP23, SP34, and SP41 are inserted between the template holders THa1 to THa4 to fix the template holders to the template stage 40. The sizes and shapes of the spacers can be suitably selected, and the template holders THai can be freely combined together. A metal or ceramics, for example, can be used as the material of the spacers. In FIG. 1, a front view of the template holders THa1 to THa4 in FIG. 2 is shown, so that the template holders THa4 and THa3 are only drawn.

The template holder THa1 is given as an example out of the four template holders THa1 to THa4 shown in FIG. 2, and its detailed structure is described. FIG. 3 is an enlarged plan view of the template holder THa1.

The template TP1 held by the template holder THa1 has a pattern formation region RP as indicated by a broken line DL in FIG. 3. In this pattern formation region RP, the shape of a pattern to be transferred to the wafer W is formed by concavities and convexities. The pattern formation region RP has a size that permits the pattern to be transferred in one imprint operation. One light exposure for transferring, to the substrate to be processed, a mask pattern used in light-exposure lithography which is generally used in semiconductor lithography is referred to as a “shot”. A size that can be exposed to light at a time is referred to as a “shot size”. Similarly, in the imprint lithography as well, the size of the pattern formation region RP is referred to as a “shot size”. This shot size varies from device to device depending on the size of a device (integrated circuit chip in the case of a semiconductor device) to be produced.

In such a method in which the templates or the template holders are arrayed to collectively transfer their patterns, the arrayed template holders have to be prepared every time to correspond to a shot map laid out on the substrate to be processed in accordance with the shot size or to correspond to the shot size (referred to as a shot image) or a shot repetition pitch.

According to the present embodiment, the spaces between the template holders THa1 to THa4 can be adjusted by suitably selecting the sizes and shapes of, for example, the spacers SP12, SP23, SP34, and SP41 shown in FIG. 2 in accordance with the individual shot map.

A second characteristic of the present embodiment is that the template holder THai is provided with a plurality of alignment elements which permit the sizes and shapes of the templates TPj to be adjusted shot by shot.

As indicated by PZa1 to PZa16 in, for example, FIG. 3, the alignment elements comprise piezoelectric bodies such as piezoelectric elements provided at predetermined intervals on the inner edge of the template holder THai made of a rigid material such as a metal or glass. A voltage is applied to or a current is passed through each of the alignment elements by an unshown electric circuit, and pressure applied to the template TPj is thereby controlled. As a result, the sizes and shapes of the templates TPj are accurately adjusted to an underlayer pattern made in the wafer W in which the pattern is to be transferred, as compared with the case where a large-area template is used or the case where a plurality of templates are fixed to the template holder.

The wafer W and the template TPj are roughly aligned with each other by mechanically moving the wafer W and the template TPj in accordance with how an alignment mark formed in the wafer W overlaps the template TPj.

In contrast, the alignment elements PZa1 to PZa16 according to the present embodiment deform the template TPj on a ppm order by applying pressure to the template TPj. If, for example, all the alignment elements PZa1 to PZa16 equally apply pressure to the template TPj, the template TPj can be reduced in size. If, for example, pressure is equally applied to the alignment elements PZa1 to PZa4 and PZa9 to PZa12 alone, the template TPj can be reduced in width. If, for example, pressure is applied to the alignment elements PZa1 and PZa12 alone, the template TPj can be changed into a trapezoidal form. In addition, the alignment elements PZa1 to PZa16 also perform fine positioning. In the present embodiment, the alignment stage 50, the alignment inspection mechanism 70, the alignment sensor 80, and the alignment elements PZa1 to PZa16 correspond to, for example, an alignment adjuster.

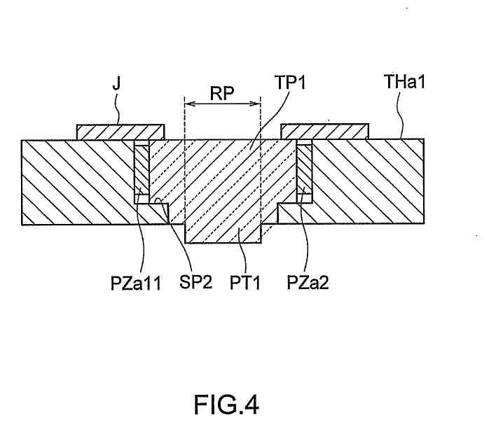

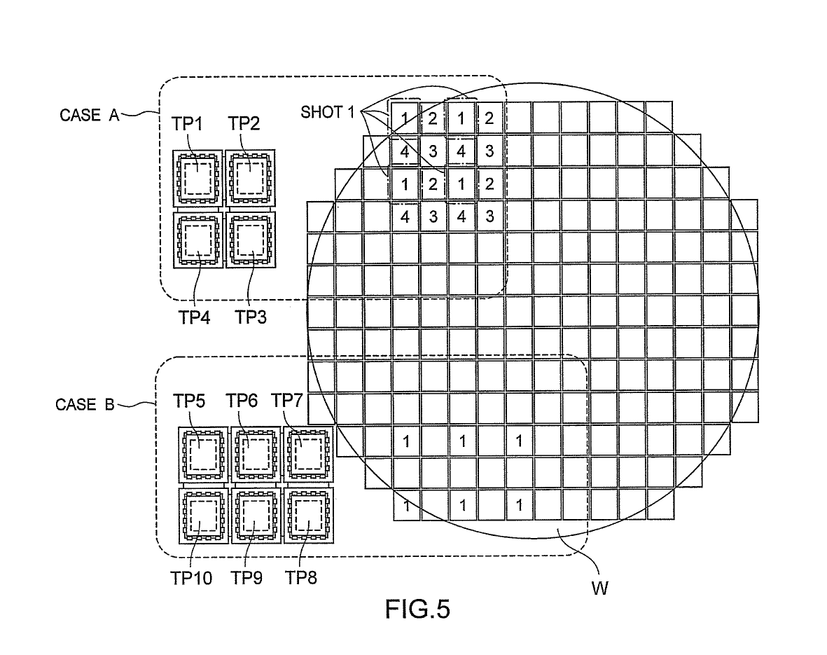

FIG. 4 is a sectional view along A-A of FIG. 3. The template TP1 is stored in the template holder THa1 so that the surface of the pattern to be transferred faces the wafer W, and the template TP1 is horizontally fixed by the alignment elements PZa1 to PZa16. In FIG. 4, the template TP1 is in a three-stepped protruding shape. Concavities and convexities of the pattern shape to be transferred to the substrate to be processed are formed in a small central protrusion PT1, and this portion serves as a pattern transfer region RP (=shot size). A step SP2 on the peripheral edge is formed for vertical fixing by the template holder THa1. A jig J for vertically fixing the template TP1 is disposed in the rear surface (the surface of the template TP1 opposite to the surface facing the wafer) of the template holder.

The relation between a shot sequence and the wafer shot map according to the imprint apparatus in the present embodiment is described with reference to FIG. 5.

In the present embodiment, the distance between the template holders THai is adjusted in accordance with the shot size and the pitch of shots to be transferred to the wafer W in order to array the templates TPj. Thus, the patterns of the shots corresponding to the number of the templates TPj are collectively transferred to the wafer W by one imprint operation. In a case A shown in the upper left part of FIG. 5, the shots indicated by the numbers 1 to 4 are collectively made in order in accordance with the shot map on the wafer W, such that the patterns of 16 shots can be transferred in four imprint operations. A case B shown in the lower left part of FIG. 5 is an example of combined six (=3×2) templates TP5 to TP10.

The templates TPj having the same shape are prepared when identical devices are produced on the wafer W. To this end, identical templates can be accurately prepared by a method of producing replica templates using a master template as an original plate.

As described above, there has already been a suggestion for a method of improving throughput by increasing the template size and thus increasing a transfer area. However, this method requires that the concavo-convex shape of the pattern to be transferred be accurately produced over the whole large-area template. On the other hand, in the imprinting that uses the imprint apparatus according to the present embodiment, high pattern transfer accuracy can be obtained over the whole region of the wafer W by freely combining the identical templates. Moreover, the alignment of each of the templates TPj can also be independently adjusted for each shot, so that the alignment accuracy of a base pattern formed in the substrate to be processed can be obtained over the whole substrate to be processed.

Thus, according to the present embodiment, the throughput of the imprint lithography can be increased in accordance with the number of the combined templates TPj, and the pattern can be accurately transferred, thereby inhibiting the decrease in the yield of device products. Consequently, in the device manufacture based on imprinting, the number of high-performance devices produced can be increased, and costs can be reduced.

Although the space between the template holders can be adjusted by the spacer materials in the case described above, it is also possible to use template holders which do not permit the adjustment of an inter-template distance. In this case, such a template holder can be prepared for each shot size based on imprinting and for each shot pitch.

(2) Second Embodiment

Now, an imprint apparatus according to a second embodiment is described. The present embodiment is characterized in that in imprinting that uses a plurality of templates TPj as in the first embodiment described above, height adjustment elements are further provided to control the heights of the templates TPj in accordance with a shot map. The configuration of the imprint apparatus according to the present embodiment is substantially the same as that in the first embodiment shown in FIG. 1 in other respects.

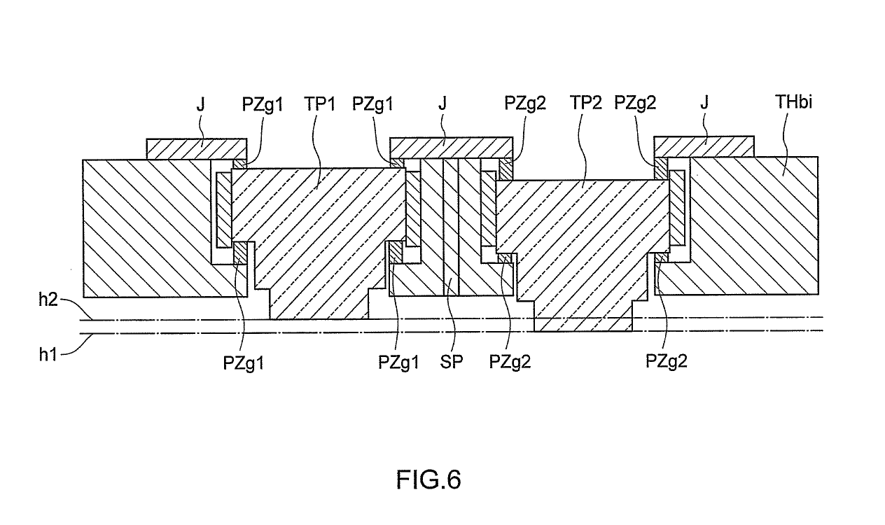

FIG. 6 is a sectional view showing essential parts of the imprint apparatus according to the present embodiment. As shown in FIG. 6, the imprint apparatus according to the present embodiment comprises template holders THbi (i is a natural number) instead of the template holders THai in the first embodiment. As apparent from the comparison with FIG. 4, the template holders THbi further include height adjustment elements PZg1 and PZg2 in addition to the components of the template holders THai. The height adjustment elements PZg1 and PZg2 are provided in the template holder THbi in contact with the upper surface and lower surface of each of the templates TPj. Similarly to the alignment elements PZa1 to PZa16 in FIG. 3, the height adjustment elements PZg1 and PZg2 comprise piezoelectric bodies such as piezoelectric elements. A voltage is applied to or a current is passed through each of the elements by an unshown electric circuit, and pressure applied to the template TPj is thereby controlled. As a result, the distance between the template TPj and a wafer W is adjusted individually. The use of the height adjustment elements PZg1 and PZg2 permits the position of each of the templates TPj in its height direction to be controlled to conform to the shot map. In the present embodiment, the height adjustment elements PZg1 and PZg2 correspond to, for example, a height adjuster, and together with a template stage 40, a base 60, and a template holding/up-down mechanism 10, correspond to, for example, a relative position control unit.

The necessity and advantages of such height alignment are described with reference to a shot map shown in FIG. 5.

For example, attention is focused on a shot 1 and a shot 2 indicated by dashed lines in FIG. 5. The template TP1 of the shot 1 is out of the wafer W, so that no imprint operation is performed in this part. The template TP1 of the shot 2 is shot in the wafer W as usual. According to the present embodiment, the position of the template TPj located at a position that needs no shot in the shot map can be lifted in its height direction by the height adjustment elements PZg1 and PZg2 so that this position may be higher than a pattern formation position. For example, in FIG. 6, the transfer surface of a pattern formation template TP2 facing the wafer W is brought to correspond to a pattern formation position h1, while the transfer surface of the template TP1 located at the position that needs no shot is lifted to correspond to a template shelter position h2.

As in the first embodiment, when there is no mechanism for independently adjusting the template TPj in its height direction, for example, no shot is made in the whole shot 1 in FIG. 5, and the sufficiently effective use of the area of the wafer W may not be possible.

According to the present embodiment, the height of each of the templates TPj can be individually controlled by the height adjustment elements PZg1 and PZg2. Thus, the templates TPj corresponding to the shot located out of the wafer W or the shot located at the position where a resist pattern is formed in advance can be moved to the template shelter position h2 at the time of the shot in accordance with the shot position (shot map) on the wafer in order to control the shot. Accordingly, the area that permits a shot is increased in the wafer W, and the area of the wafer can be efficiently used. As a result, the number of chips in a semiconductor device that can be acquired from one wafer is increased, and the manufacturing costs can be reduced. Moreover, no imprint operation is performed on the surface that is not continuous from the center of the waver, for example, the outside or outer peripheral part of the wafer. This makes it possible to inhibit any damage to members in other components of the device or the templates TPj on the edge of the wafer, and to prolong the lives of the templates TPj. As a result, a semiconductor device can be manufactured with a smaller number of templates, which can also contribute to the reduction of the manufacturing costs.

If the above-described height control of the individual templates using the height adjustment elements PZg1 and PZg2 is used for the release of the template from the resist, the throughput and accuracy of the imprint operation can be more improved.

In general, when the template TPj is released from the resist pattern after a resist pattern is formed by bringing the template TPj into contact with the resist material, force necessary for the release increases as the area of contact between the template TPj and the resist pattern increases. If all the template holders THa1 to THa4 for holding the arrayed four templates TP1 to TP4 in the first embodiment described above are generically called THa, force four times as great as that for a single template holder THi is needed to lift the template holder THa to release this template holder. If this force is extremely great, the template holder THa may drop from the template stage 40 (see FIG. 1) when the template holder THa is lifted. In some cases, the wafer W in which the resist pattern is formed may otherwise be lifted in contact with the template TPj from the wafer stage 110 and the wafer chuck 100. This is attributed to the fact that if the area for forming patterns on the wafer W at a time and the number of templates that can be released at a time are increased, force necessary to release the template becomes greater than, for example, the force that sticks the template stage 40 and the template TPj, the force that sticks the wafer W and the wafer stage 110, and the force that sticks the wafer W and the resist.

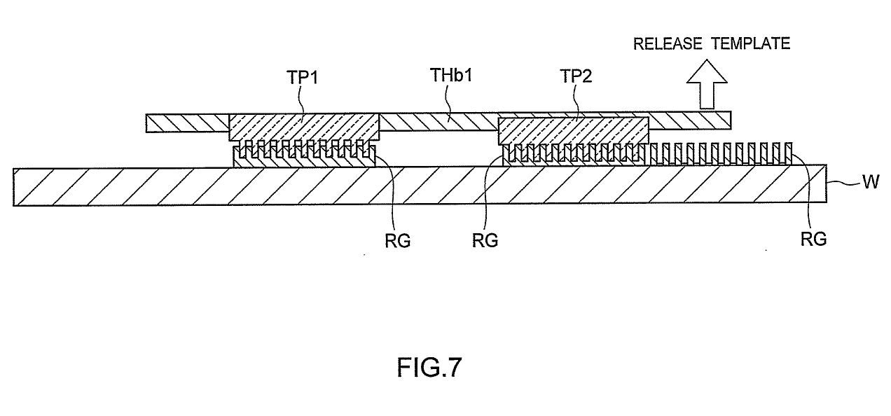

Accordingly, the template holders THbi (totally referred to as THb) configured to respectively include the height adjustment elements PZgk (k is a natural number) for controlling the height of the templates TPj are prepared. The respective templates TPj are sequentially lifted in a slight amount before the whole template holder THb is collectively released from the resist, such that the area of the surface of the template in contact with the resist can be reduced. To explain with the example shown in FIG. 7, if the template TP1 is lifted in a slight amount before the whole template holder THb including the template holder THb1 is collectively released from a resist RG, the area in contact with the resist RG is reduced by the surface of the templates TPj, and the template TP2 can be smoothly released. According to the present embodiment, timing control of the individual imprint operations which has been difficult for conventional techniques is enabled by a simple configuration in simultaneous imprint operation of a plurality of templates. The height at which the individual templates TPj are lifted may be equal to or less than the thickness of the resist.

In the present embodiment, before the release of the whole template holder THb, the time for the height control of the individual templates TPj is added to a shot time. This may lead to a slight increase in the time required for a shot. However, the disadvantage of an increase in the time for one shot for imprinting a plurality of templates is extremely limited when the advantage of the reduced shot time resulting from collective imprinting of a plurality of templates is taken into consideration.

For example, the time for imprinting of one shot is 1.2 seconds. In this case, in accordance with, for example, the shot map in FIG. 5, as there are 184 shots in the whole wafer, the total shot time in the whole wafer W is 3.7 minutes in the conventional imprinting that uses one template. In contrast, if four shots are collectively imprinted as in the case A of FIG. 5, a pattern can be formed in the whole wafer by 44 shots. Therefore, the time required for imprinting in the whole wafer is reduced to 0.88 minutes (52.8 seconds) which is 1/(4.2).

In contrast, when the heights of the templates TPj are sequentially controlled before release as in the present embodiment, the imprinting time for one shot is 1.4 seconds in the case of four templates if the height is controlled for one template within 0.05 seconds (50 ms). As there are actually templates for which no imprinting is performed such as the shot 1 of FIG. 5, the time required for imprinting in the whole wafer is 1.0 minute (612 seconds). This is 3.7 times as rapid as that in the conventional case, and amounts to a time increase of about 16% compared with the case A of FIG. 5.

Thus, according to the present embodiment, the heights of the individual templates TPj are controlled before the release of the whole template holder THb, so that force necessary for the release can be reduced, and accidents such as the dropping of the template TPj and the lifting of the wafer W can be inhibited. This makes it possible to achieve more efficient use of the templates TPj and the wafer W, improve the yield of semiconductor devices, improve manufacturing quantity, and inhibit, for example, a cost increase attributed to reproduction of templates as a result of accidental template breakage. Consequently, more semiconductor devices can be manufactured at low costs.

While the light-curing imprint apparatus which cures a resist by light irradiation has been described by way of example in the embodiments, it should be understood that the present invention is not limited to thereto and is also applicable to a heat-curing imprint apparatus. In this case, the imprint apparatus can be provided with a heater and a pressure device instead of the UV light source 90.

(3) Addition

According to the embodiments described above, an imprint apparatus that highly accurately and efficiently performs a pattern transfer is provided.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An imprint apparatus comprising:
a template holder configured to hold a plurality of templates in an arrayed form, each of the templates comprising a shape of a pattern to be transferred to a substrate to be processed;
a space adjusting unit configured to adjust a space between the templates to a desired value;
a relative position control unit configured to control relative positions of the templates and the substrate to be processed to bring the templates into contact with a resist on the substrate to be processed; and
a curing unit configured to cure the resist while the templates are in contact with the resist.

2. The apparatus of claim 1,
wherein an underlayer pattern is formed in the substrate to be processed in advance,
the apparatus further comprising an alignment adjuster configured to adjust at least one of the size and shape of each template in accordance with the underlayer pattern.

3. The apparatus of claim 2,
wherein the alignment adjuster comprises a piezoelectric body on an inner edge of the template holder.

4. The apparatus of claim 1,
wherein the relative position control unit further comprises a height adjuster configured to adjust a height of each template.

5. The apparatus of claim 4,
wherein the relative position control unit controls the height adjuster in a manner that each template is controlled to be in and out of contact with the resist in accordance with the presence of a resist pattern to be formed.

6. The apparatus of claim 4,
wherein the relative position control unit controls the height adjuster in a manner that the respective templates are separated from the cured resist by different timings.

7. The apparatus of claim 4,
wherein the height adjuster comprises a piezoelectric body provided in at least one of an upper surface or a lower surface of the template.

8. The apparatus of claim 1,
wherein the curing unit comprises a light source configured to generate light and apply the light to the resist.

9. The apparatus of claim 1,
wherein the curing unit comprises a heater configured to generate heat and to heat the resist.

10. An imprint method comprising:
holding a plurality of templates in an arrayed form, each of the templates comprising a shape of a pattern to be transferred to a substrate to be processed;
adjusting a space between the templates to a desired value;
controlling relative positions of the templates and the substrate to be processed to simultaneously bring the templates into contact with a resist on the substrate to be processed; and
curing the resist while the templates are in contact with the resist.

11. The method of claim 10,
wherein an underlayer pattern is formed in the substrate to be processed in advance,
the method further comprising adjusting at least one of the size and shape of each template in accordance with the underlayer pattern.

12. The method of claim 10, further comprising adjusting a height of each template.

13. The method of claim 12,
wherein the height of each template is adjusted in accordance with a shot map.

14. The method of claim 13,
wherein each template is controlled to be in and out of contact with the resist in accordance with the presence of a resist pattern to be formed.

15. The method of claim 12,
wherein the respective templates are separated from the cured resist by different timings.

16. The method of claim 10,
wherein the resist is cured by light.

17. The method of claim 10,
wherein the resist is cured by heat.
